(19) United States
(12) Patent Application Publication
(10) Pub. No.: US 2026/0095036 A1
(43) Pub. Date: Apr. 2, 2026

(54) Lock Box For Wire Cable Clamps

(71) Applicant: Francisco Hernandez, San Diego, CA (US)

(72) Inventor: Francisco Hernandez, San Diego, CA (US)

(21) Appl. No.: 19/241,854

(22) Filed: Jun. 18, 2025

Related U.S. Application Data
(63) Continuation-in-part of application No. 18/904,783, filed on Oct. 2, 2024.

(51) Int. Cl. H02G 15/113; B25B 5/04; E05B 9/00; E05B 57/00; E05B 65/52

(52) U.S. Cl. CPC H02G 15/113; B25B 5/04; E05B 57/00; E05B 65/5253; E05B 2009/004

(57) ABSTRACT

A lock box for wire cable clamps includes a body, a hinge, and a locking assembly. The hinge pivotably connects a first body section and a second body section to permit opening of the body and closing of the body about wire cable clamps on a wire cable. A first end face and a second end face are positioned at opposite ends of the body, each having an aperture designed to permit passage of the wire cable and prevent passage of wire cable clamps when the body is closed. The locking assembly is positioned on the body and is engageable by a lock to releasably lock the first body section and the second body section. A tether plate extends from the body and has a hole for connection of a tether to the body.

### CROSS-REFERENCE TO RELATED APPLICATIONS

This application is a continuation in part of application Ser. No. 18/904,783 filed Oct. 2, 2024.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to wire cable clamp locks and more particularly pertains to a new lock box for securing wire cable clamps. In the construction field and other industries, wire cables are used to steady or secure structures under a load. In order to secure the wire cables, they can either have an eyelet formed at the end or two wire cables can be connected together. Both of these formations are achieved using wire cable clamps, also known as rope clips. The wire cable clamps generally consist of a saddle, a U-bolt, and a pair of nuts to secure the saddle to the legs of the U-bolt. The wire cable clamp is placed around a wire cable. When forming an eyelet, two sections of a single wire cable are held between the saddle and the U-bolt, whereas when connecting two separate wire cables, one section from each of the wire cables is held between the saddle and the U-bolt. Connecting the wire cable clamps properly requires training and some precision, as improperly connected wire cable clamps could either damage the wire cable or break free under load, which could be very dangerous. Once connected, wire cable clamps often need to be loosened, adjusted, or even disconnected, such as to make room to bring materials and vehicles into a work area. Unfortunately, in many instances the persons adjusting or disconnecting the wire cable clamps either reconnect them improperly or not at all, which can result in a very dangerous situation that could end in significant damage to property or severe injury or death to workers. The new lock box allows a user to secure installed wire cable clamps from tampering by unauthorized persons, thereby ensuring that adjustment or disconnection is done either by or under the supervision of an authorized person.

### (2) Description of Related Art Including Information Disclosed Under 37 CFR 1.97 and 1.98

The prior art relates to wire cable clamp locks. The prior art, as best understood, does not disclose a lock box for wire cable clamps includes a body, a hinge, a first end face and a second end face, and a locking assembly, wherein the body is openable and closable about wire cable clamps on a wire cable, and has a locking assembly designed to be engaged by a lock to releasably lock the body and prevent tampering with the wire cable clamps held therein.

### BRIEF SUMMARY OF THE INVENTION

An embodiment of the disclosure meets the needs presented above in a lock box generally comprising a body, a hinge, a first end face, a second end face, and a locking assembly. The body is hollow and divided into a first body section and a second body section. The hinge pivotably connects the first body section and the second body section to permit opening of the body and closing of the body about wire cable clamps on a wire cable. The first end face and the second end face are positioned at opposite ends of the body, each having an aperture therein designed to permit passage of a wire cable therethrough and prevent passage of wire cable clamps therethrough when the body is closed about the wire cable clamps on the wire cable. The locking assembly is positioned on the body and is designed to be engaged by a lock to releasably lock the first body section and the second body section.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top open perspective view of a lock box according to an embodiment of the disclosure.

FIG. 2 is a bottom rear perspective view of an embodiment of the disclosure.

FIG. 3 is a front view of an embodiment of the disclosure.

FIG. 4 is a cross-sectional view of an embodiment of the disclosure.

FIG. 5 is a perspective view of an embodiment of the disclosure in use.

FIG. 6 is a perspective view of an embodiment of the disclosure in use.

### DETAILED DESCRIPTION OF THE INVENTION

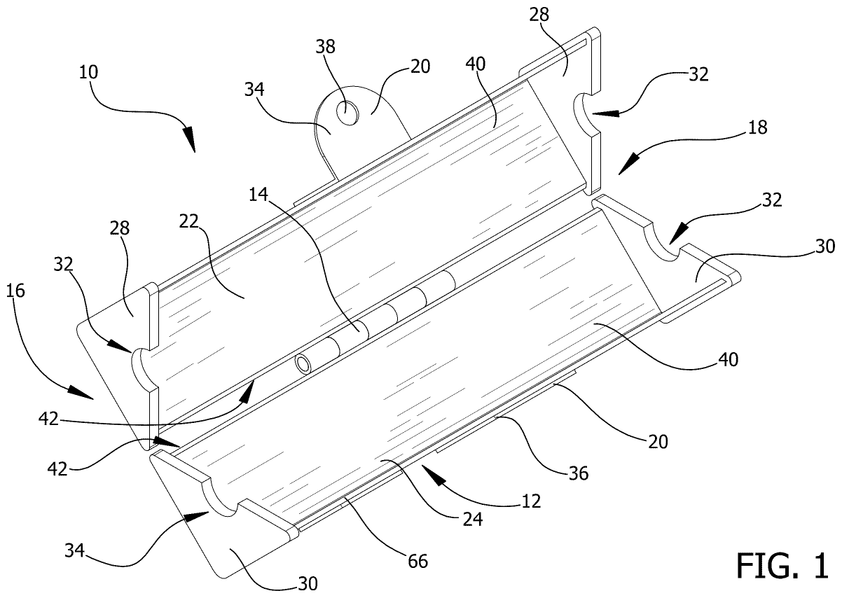

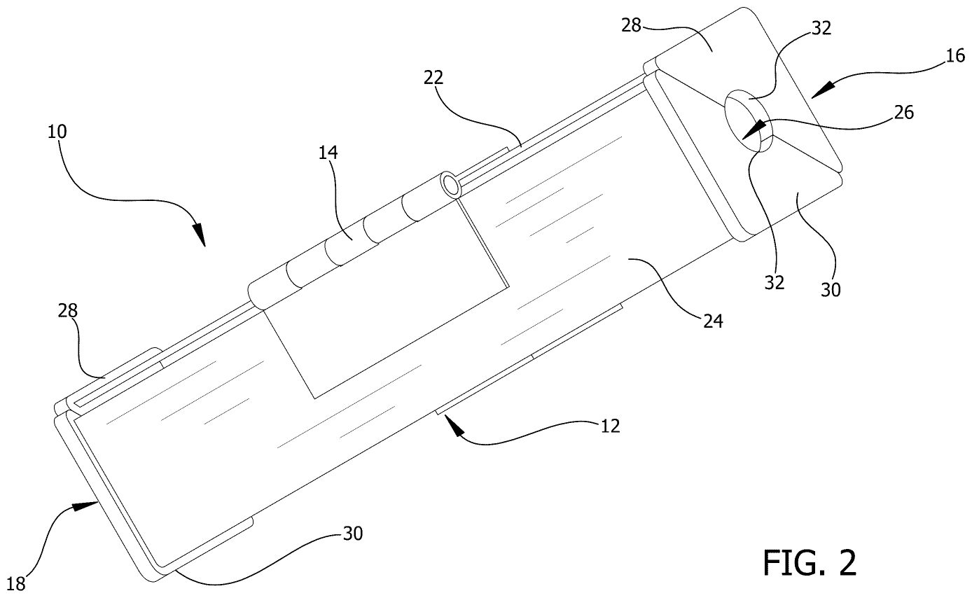

With reference now to the drawings, and in particular to FIGS. 1 through 6 thereof, a new lock box embodying the principles and concepts of an embodiment of the disclosure and generally designated by the reference numeral 10 will be described.

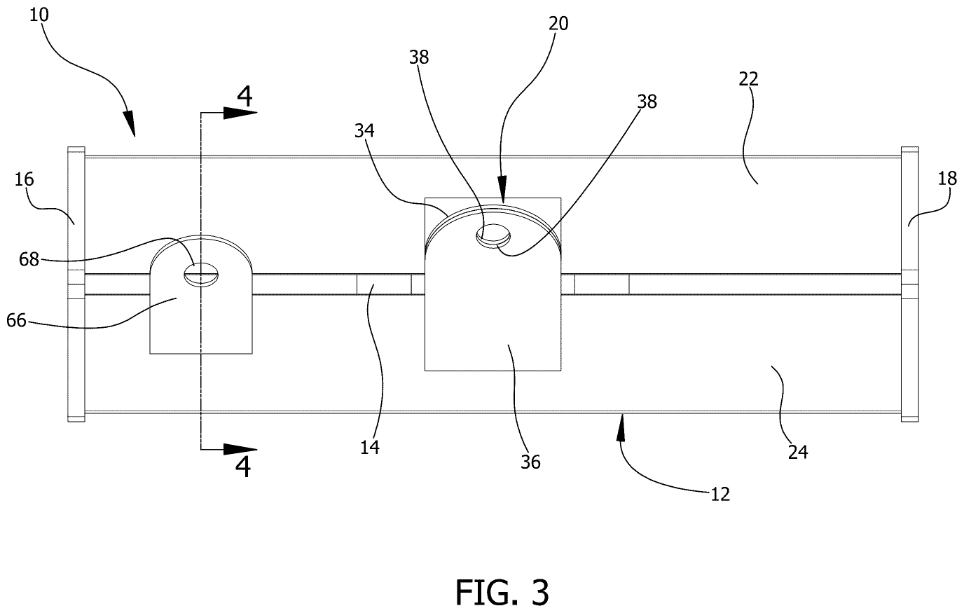

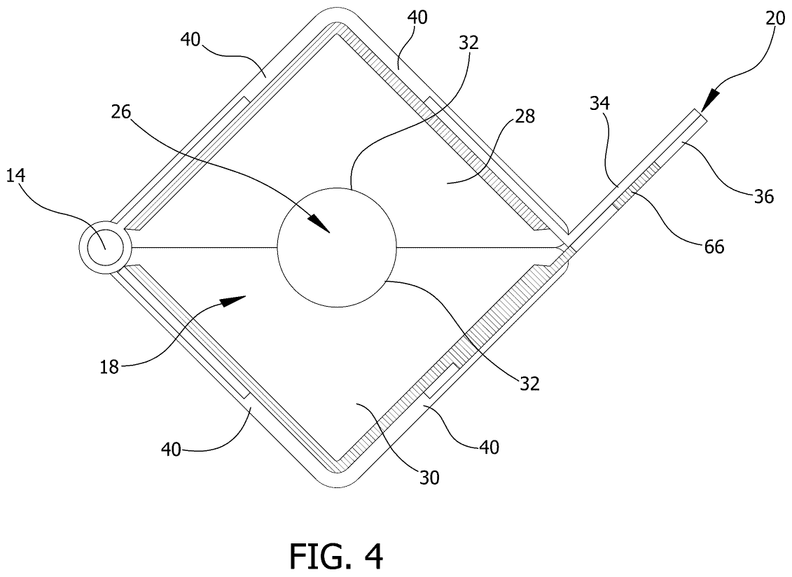

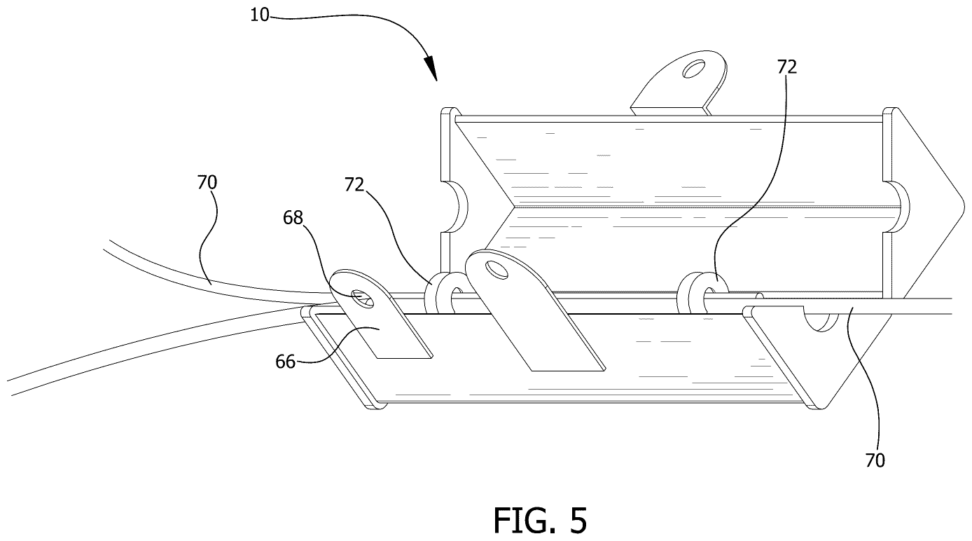

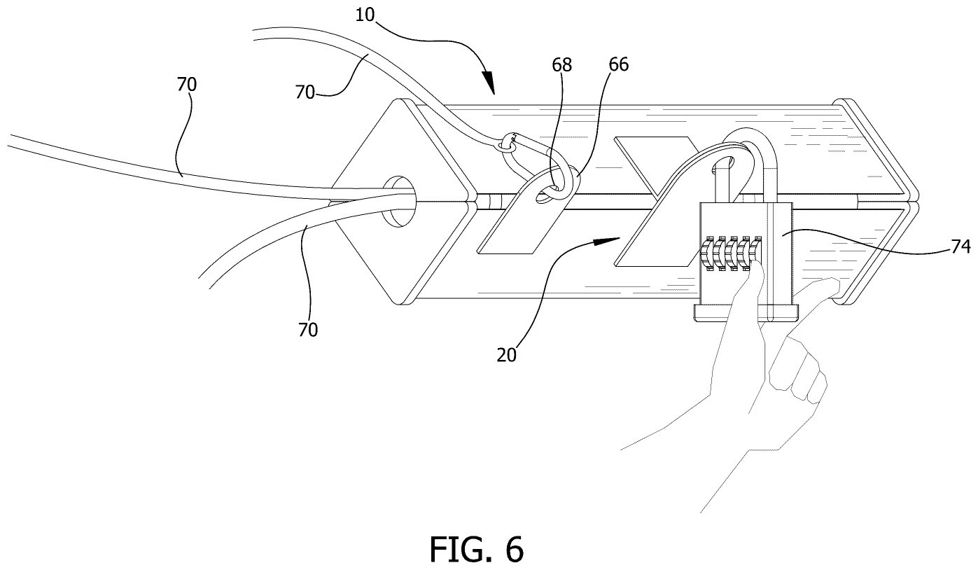

As best illustrated in FIGS. 1 through 6, the lock box 10 generally comprises a body 12, a hinge 14, a first end face 16, a second end face 18, and a locking assembly 20. The body 12 is hollow and divided into a first body section 22 and a second body section 24. The hinge 14 pivotably connects the first body section 22 and the second body section 24 to permit opening 38 of the body 12 and closing of the body 12 about wire cable clamps 72 on a wire cable 70, as shown in FIGS. 5 and 6. As best seen in FIGS. 3 and 4, the first end face 16 and the second end face 18 are positioned at opposite ends of the body 12. Each has an aperture 26 therein designed to permit passage of the wire cable 70 therethrough and to prevent passage of wire cable clamps 72 therethrough when the body 12 is closed about the wire cable clamps 72 on the wire cable, as shown in FIGS. 5 and 6. The locking assembly 20 is positioned on the body 12 and is designed to be engaged by a lock to releasably lock the first body section 22 and the second body section 24, such as a padlock 74 as shown in FIG. 6.

In the exemplary embodiment, each of the first end face 16 and the second end face 18 is divided into a first end portion 28 and a second end portion 30, as shown in FIG. 1. The first end portions 28 are attached to the first body section 22 and the second end portions 30 are attached to the second body section 24. In the exemplary embodiment, each of the first end portions 28 and the second end portions 30 includes a recess 32 therein. Each of the recesses 32 forms a part of a corresponding one of the apertures 26 to permit opening 38 and closing of the apertures 26 about the wire cable 70. Each of the recesses 32 has a semi-circular cross-sectional profile and each of the apertures 26 is circular. While the exemplary embodiment shows that each aperture 26 is formed by two identical recesses 32 that are essentially halves of the aperture 26, other configurations, such as where the recesses 32 are different shapes or sizes, are within the scope of the disclosure.

As best seen in FIG. 5, the locking assembly 20 includes a first tab 34 projecting from the first body section 22 and a second tab 36 projecting from the second body section 24. Each of the first tab 34 and the second tab 36 includes an opening 38 therein designed to be aligned when the body 12 is closed to permit insertion of the padlock 74 or wire lock device. In the exemplary embodiment, the first tab 34 is in the form of an L-shaped bracket, whereas the second tab 36 is a flat plate. Other shapes that would provide a place to connect the padlock 74 or wire lock device are within the scope of the disclosure.

In the exemplary embodiment, the body 12 is elongated to closely follow the elongated shape of the wire cable 70, though the body 12 could be about the same length and width in one possible embodiment. The first body section 22 and the second body section 24 form equal halves of the body 12, so the body 12 has essentially a clamshell design, though other designs in which the first body section 22 and the second body section 24 are different sizes and shapes are within the scope of the disclosure. The body 12 is a rectangular tube that includes four side panels 40, though the body 12 could be a cylindrical tube or other shape. Each of the first body section 22 and the second body section 24 is an L-shaped bracket that includes two of the four side panels 40. The hinge 14 is positioned at a pair of adjacent side edges 42 of the first body section 22 and the second body section 24. Each of the first end face 16 and the second end face 18 is square, and each of the first end portions 28 and the second end portions 30 is a triangular half thereof. In an alternative embodiment, the hinge 14 could be formed in one of the side panels 40 and the opposing side panel 40 could be split in half, such that the body 12 opens in two U-shaped halves rather than triangular troughs as shown in the figures. In another possible embodiment, three of the side panels 40 could form a U-shaped portion of the body 12 with the fourth side panel attached by the hinge 14 and essentially forming a pivotable cover. The body 12 can be made of metal or possibly a heavy-duty plastic for durability and weather resistance.

A tether plate 66 is coupled to and extends from the body 12. The tether plate 66 has a hole 68 extending through the tether plate 66. Thus, the tether plate 66 is configured for receiving a tether 70 through the hole 68. The tether plate 66 extends from the second body section 24. The tether plate 66 is coplanar with and laterally spaced from the second tab 36.

To use the lock box 10, the user opens the body 12, as shown in FIG. 5, and places the body 12 adjacent the wire cable 70 that has wire cable clamps 72 already connected. The user aligns the wire cable 70 in the recesses 32, then closes the body 12, as shown in FIG. 6, with the wire cable clamps 72 inside and the wire cable extending out through the apertures 26. A lock, such as the padlock 74 shown in FIG. 6, is then passed through the aligned openings 38 in the first tab 34 and the second tab 36 to secure the lock box 10 in the closed state. While in the exemplary embodiment the lock box 10 is shown covering a connection between two separate wire cables 70, the lock box 10 could also be used with a single wire cable used to form an eyelet. Since the apertures 26 are too small for the wire cable clamps 72 to pass through, the lock box 10 cannot be slid along the wire cable 70 to permit access to the wire cable clamps 72.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A lock box for wire cable clamps comprising:
a body being hollow and divided into a first body section and a second body section;
a hinge pivotably connecting said first body section and said second body section to permit opening of said body and closing of said body about wire cable clamps on a wire cable;
a first end face and a second end face being disposed at opposite ends of said body, each having an aperture therein configured to permit passage of a wire cable therethrough and prevent passage of wire cable clamps therethrough when said body is closed about the wire cable clamps on the wire cable;
a locking assembly being disposed on said body and being configured to be engaged by a lock to releasably lock said first body section and said second body section; and
a tether plate coupled to and extending from said body, said tether plate having a hole extending through said tether plate wherein said tether plate is configured for receiving a tether through said hole.

2. The lock box of claim 1, wherein:
each of said first end face and said second end face is divided into a first end portion and a second end portion, wherein said first end portions are attached to said first body section and said second end portions are attached to said second body section; and
each of said first end portions and said second end portions comprises a recess therein, wherein each of said recesses forms a part of a corresponding one of said apertures to permit opening and closing of said apertures about a wire cable.

3. The lock box of claim 2, wherein each of said recesses has a semi-circular cross-sectional profile and each of said apertures is circular.

4. The lock box of claim 1, wherein said locking assembly comprises a first tab projecting from said first body section and a second tab projecting from said second body section, wherein each of said first tab and said second tab comprises an opening therein configured to be aligned when said body is closed to permit insertion of a padlock or wire lock device.

5. The lock box of claim 1, wherein said body is elongated.

6. The lock box of claim 1, wherein said first body section and said second body section form equal halves of said body.

7. The lock box of claim 1, wherein said body is a rectangular tube comprising four side panels.

8. The lock box of claim 7, wherein each of said first body section and said second body section is an L-shaped bracket comprising two of said four side panels.

9. The lock box of claim 1, wherein said hinge is disposed at a pair of adjacent side edges of said first body section and said second body section.

10. The lock box of claim 1, wherein each of said first end face and said second end face is square, and each of said first end portions and said second end portions is a triangular half thereof.

11. The lock box of claim 3, wherein said locking assembly comprises a first tab projecting from said first body section and a second tab projecting from said second body section, wherein each of said first tab and said second tab comprises an opening therein configured to be aligned when said body is closed to permit insertion of a padlock or wire lock device.

12. The lock box of claim 11, wherein said body is elongated.

13. The lock box of claim 12, wherein said first body section and said second body section form equal halves of said body.

14. The lock box of claim 13, wherein said body is a rectangular tube comprising four side panels.

15. The lock box of claim 14, wherein each of said first body section and said second body section is an L-shaped bracket comprising two of said four side panels.

16. The lock box of claim 15, wherein said hinge is disposed at a pair of adjacent side edges of said first body section and said second body section.

17. The lock box of claim 16, wherein each of said first end face and said second end face is square, and each of said first end portions and said second end portions is a triangular half thereof.

18. The lock box of claim 4, wherein said tether plate is coplanar with and laterally spaced from said second tab.
